(19) United States
(12) Patent Application Publication
(10) Pub. No.: US 2009/0078763 A1
(43) Pub. Date: Mar. 26, 2009

(54) Contact-less smart card reader

(75) Inventor: Duraipandianadar Balasubramanian, Tansi Nagar (IN)

Correspondence Address: PROSKAUER ROSE LLP, ONE INTERNATIONAL PLACE, BOSTON, MA, 02110, US

(73) Assignee: Scolis Technologies (India) PVT. Ltd., Neelangarai (IN)

(21) Appl. No.: 12/217,371

(22) Filed: Jul. 3, 2008

(30) Foreign Application Priority Data
Sep. 20, 2007 (IN) 2118/CHE/2007

(51) Int. Cl. G06K 7/10

(52) U.S. Cl. 235/439

(57) ABSTRACT

An improved contact-less smart card reader is disclosed that includes at least one separate transmit antenna and at least one separate receive antenna for transmitting and receiving respectively, wherein the antenna geometry of said reader is adapted to capture a maximum number of flux lines that pass through the corresponding smartcard and a minimum number of flux lines that do not pass though the corresponding smartcard, thereby increasing the signal to noise ratio in the reader and consequently, increasing the strength of the signal qualities received from the smart card, particularly in the event of operation of the smart card from a substantial operating distance. A method is also provided for assembling an improved contact-less smartcard reader as described above.

### RELATED APPLICATIONS

This application claims priority under 35 U.S.C. § 119 or 365 to Indian Patent Application No. 2118/CHE/2007, filed on May 8, 2008, which claims priority to Indian Provisional Patent Application No. 2118/CHE/2007, filed on Sep. 20, 2007. The entire teachings of the above applications are incorporated herein by reference.

### FIELD OF THE INVENTION

The present invention, in general, relates to an improved contact-less smart card reader, and in particular, to a contact-less smart card reader having improved antenna geometry, whereby signal to noise ratio in the reader is increased and consequently the strength and quality of a signal received from a contact-less smart card are increased.

### BACKGROUND OF THE INVENTION

Conventional contact-less smart card readers are made up of reader silicon, passive filter circuits and antenna. Smart cards can operate over 13.56 MHz RF frequency based on the ISO14443 or ISO15693 or ISO18000-3 standard, for example. The smart card readers transmit power to a contact-less smartcard by means of a magnetic field over the carrier frequency. Data from the smart card reader is transmitted to the contact-less smartcard by means of amplitude modulation on the carrier. The contact-less smart cards internally generate power for itself from the magnetic field generated by the reader and transmit back the data by means of load modulation over the carrier.

Most of the smart card readers known in the art use a common antenna for transmission and reception. In most cases, when a contact-less smart card remains in operation at its maximum operating distance, the card is able to receive enough power and respond back to commands. However, the deficiencies in geometry and structure of the antenna in the corresponding reader result in receipt of feeble signal qualities from the card by the reader thereby causing hindrance to reading of the card from a substantial operating distance.

Heretofore, no one has explicitly addressed the issue of improving the readability of a contact-less smart card reader by increasing the received signal strength, particularly when reading of the card is required to be performed from a substantial operating distance.

For example, JP 2004-328605 discloses utilization of two transmitting antenna, one receiving antenna and a switching circuit to select one of the transmitting antenna and solves the problem of how to manage entry and exit with a single contact-less smart card reader unit. This application therefore does not address the aforesaid issue. Similarly, JP2000-293641 discloses a reduction in the system cost by having one reader integrated circuit (IC) system and two antennas and reading the card through either of the antenna. JP2002-063552 aims at reducing the size of the overall system by antenna arrangement. WO/2007/080214 discloses how to solve the problem of contact (e.g., rust) between the electronics and the antenna inside the reader. WO/2007/07401 discloses operation of two antennas, one operating at fixed frequency and the other operating at variable frequency. This application discusses how to read data from multiple e-VISA cards, each card transmitting data at different frequencies.

Hence, none of the aforesaid prior art documents address the issue of improving the readability of contact-less smart card reader by increasing the received signal strength, particularly when reading of the card is required to be performed from a substantial operating distance

Accordingly, there has been a long felt need to develop a contact-less smart card reader having improved antenna geometry, thereby facilitating an increase in signal to noise ratio in the reader, and consequently an increase in strength of signal qualities received from a contact-less smart card by the reader particularly in the event of operation of said smart card from a substantial operating distance, so as to enable accurate reading of the smart card from said substantial operating distance. Embodiments of the present invention meet the aforesaid long felt need.

### SUMMARY OF THE INVENTION

Accordingly, embodiments of the present invention provide an improved contact-less smart card reader including at least one separate transmit antenna and at least one separate receive antenna for transmitting and receiving respectively, wherein the antenna geometry of said reader is adapted to capture maximum number of flux lines that pass through the corresponding smart card and minimum number of flux lines that do not pass though the corresponding smartcard, thereby increasing the signal to noise ratio in the reader and consequently, increasing the strength of the signal qualities received from the smart card, particularly in the event of operation of said smart card from a substantial operating distance. Preferred embodiments of the contact-less smart card reader of the present invention can include one or more of the following features.

The receive coil of the receive antenna can be adapted to have a geometrical shape to capture maximum number of flux lines that pass through the card and minimum number of flux lines that do not pass though the card.

The reader can comprise a plurality of separate transmit antenna and receive antenna for the purpose of transmitting and receiving respectively.

The receive antenna can be smaller in size than the transmit antenna, preferably bigger in size than the antenna of the card.

The reader can include a processor for issuing commands to the contact less smart card and for receiving the response from the smart card; a memory for storing the software program, the data and all other relevant information to read and write into the contact-less smart card; a reader IC for serializing the data and converting it into standardized frames for further onward functioning; and a matching circuit for matching the impedance of the card to the source impedance and creating resonance to drive the power through the transmit antenna.

The matching circuit can be a passive circuit and the transmit antenna can be adapted to transmit power by means of alternating magnetic field carrier wave and to transmit the data to the card by means of modulation on the carrier wave. The receive antenna can be adapted to receive the signal from the card and to give it to the reader IC through the matching filter circuit.

The transmit antenna and receive antenna can be fabricated such that each fall in different planes and are non-concentric.

The transmit antenna and receive antenna can be fabricated on the same plane, rectangular with curved corners and concentric to a same center point.

The transmit antenna and receive antenna can be fabricated on two different planes, rectangular with curved corners and concentric to a common axis.

Embodiments of the present invention can also provide a contact-less smart card system including at least one contact-less smart card having improved performance and higher operating distance and operatively coupled to at least one improved contact-less smart card reader having improved antenna geometry. Preferred embodiments of the contact-less smart card reader system of the present invention can include one or more of the following features.

The contact-less smart card can be positioned in between the reader transmit antenna and reader receive antenna.

The contact-less smart card can be positioned away from the reader transmit/receive antenna.

Embodiments of the present invention can also provide a method for assembling an improved smart card reader that includes providing and operatively connecting a processor, a memory, a reader IC, a matching circuit and at least one separate transmit antenna and at least one separate receive antenna for transmitting and receiving respectively, wherein the method comprises designing the antenna geometry of the reader so as to facilitate capturing maximum number of flux lines that pass through the corresponding smart card and minimum number of flux lines that do not pass though the corresponding smart card thereby increasing the signal to noise ratio in the reader and consequently, increasing the strength of the signal quality received from the smart card, particularly in the event of operation of said smart card from a substantial operating distance.

In accordance with a preferred embodiment of the method for assembling an improved smart card reader of the present invention can further comprise designing the receive coil of the receive antenna to a geometrical shape for facilitating capturing maximum number of flux lines that pass through the card and minimum number of flux lines that do not pass through the card.

### BRIEF DESCRIPTION OF THE DRAWINGS

The nature and scope of the present invention will be better understood from the accompanying drawings, which are by way of illustration of some preferred embodiments and not by way of any sort of limitation. In the accompanying drawings.

FIG. 1 illustrates a contact-less smart card system in accordance with a preferred embodiment of the present invention.

FIG. 2 illustrates a block diagram showing the various components of the smart card reader in accordance with a preferred embodiment of the present invention.

FIG. 3 illustrates an arrangement of the smart card reader antenna in accordance with a preferred embodiment of the invention.

FIG. 4 illustrates another arrangement of the smart card reader antenna in accordance with another preferred embodiment of the present invention.

### DETAILED DESCRIPTION OF EMBODIMENTS OF THE INVENTION

The following includes description of particular embodiments of the present invention, which is purely for the sake of understanding and not by way of any sort of limitation.

As stated aforesaid, the present invention primarily aims at increasing the signal qualities received from a smart card by improving the antenna geometry of the smart card reader. This technical advancement was hitherto unknown and not conceived by persons skilled in the art.

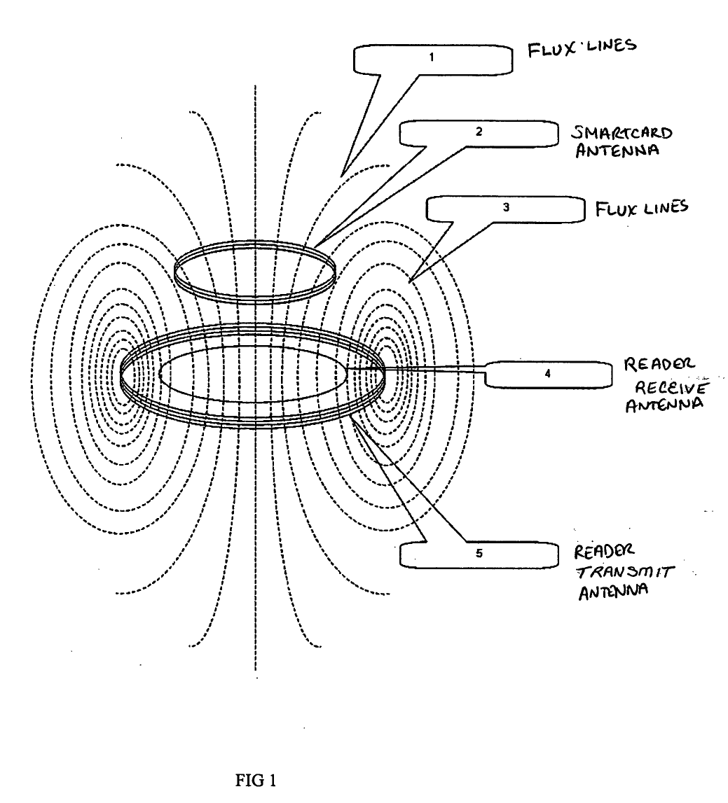

From FIG. 1 and the foregoing description it ought to be clear that the card sends data to the reader by means of load modulation on the carrier. When the card does load modulation, the total number of flux lines that pass through the transmitting antenna of the reader changes. This change in number of flux lines is recognized by the reader as change in voltage and this is used to receive data from the contact-less smart card.

Similarly, when the card does load modulation, the total number of flux lines that pass through the card also changes. When the change in number of flux lines is analyzed in terms of a ratio, this ratio measured at the card is always greater than the ratio measured at the transmit antenna of the reader.

As can be understood from the FIG. 1, the contact-less smart card system in accordance with an embodiment of the invention comprises a contact-less smartcard having antenna 2 inside it, in operation at a substantial distance from a contact-less smart card reader having at least one transmitting antenna 5 and at least one receiving antenna 4. Preferably, the transmitting antenna is larger in size than the receiving antenna and the receiving antenna is larger in size than the antenna of the smart card. The receiving antenna's 4 shape and size is geometrically designed, so as to capture a maximum number of magnetic flux lines 1 that pass through the card and a minimum number of flux lines 3 that do not pass through the card. This geometry, together with the dual antenna arrangement, facilitate an increase in a signal to noise ratio with a consequential increase in strength of signal qualities received from a contact-less smart card by the reader in the event of operation of the smart card from a substantial operating distance, so as to enable accurate reading of the smart card from a substantial operating distance. The increased receive signal strength provides a lesser number of error retry loops and thereby, also improves the performance and enables higher operating distance for the contact-less smart card.

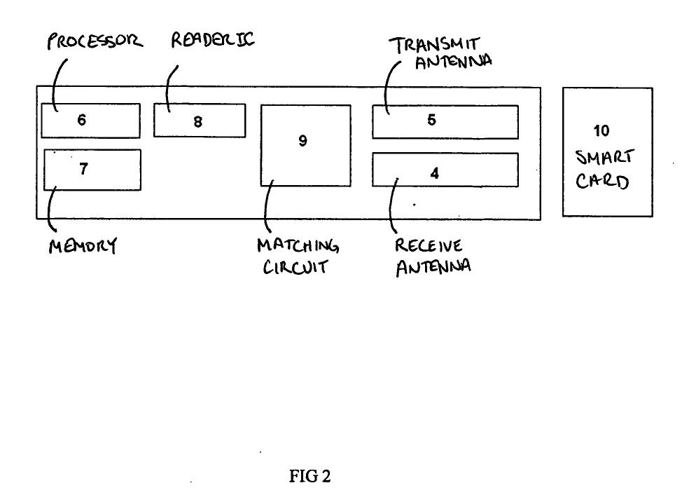

The accompanying FIG. 2 illustrates a flow diagram of the various components of the smart card reader, in accordance with an embodiment of the invention. The various components as shown include (1) Processor 6, which issues commands to the contact-less smartcard and receives the response from the smartcard; (2) Memory 7 which stores the software program, the data and all other relevant information to read and write into the contact-less smart card; (3) Reader IC 8 which serializes the data and converts it into frames as per ISO14443 or ISO15693 or ISO18000-3 standard, for example. It generates the power for the card, performs modulation of the transmitted data over the carrier, decodes the received signal and converts it back to data readable by the processor; (4) Matching circuit 9 is a passive circuit that matches the impedance of the card to the source impedance and creates resonance to drive the power through the transmit antenna; (5) Transmit antenna 5 that transmits power by means of alternating magnetic field carrier wave and transmits the data to the card by means of modulation on the carrier wave; (6) Receive antenna 4 that receives the signal from the card and gives it to the Reader IC through the matching filter circuit. In the accompanying FIG. 2, reference numeral 10 represents contact-less smart card.

### Transmission to the Smart Card Takes Place as Follows:

The smart card reader generates a carrier waveform in the format of alternating magnetic field. The card uses an internal coil to convert the alternating magnetic field to electricity and uses that power for its internal operation.

The smart card reader modulates the carrier waveform as per ISO14443 or ISO15693 or ISO18000-3 standard, for example, and thus transmits data to the card. The card uses its internal coil to convert this alternating magnetic field to electricity. Since the magnetic field is modulated, the electricity generated inside the card is also modulated. The card demodulates this electric signal and receives the data for it.

Reception from the Card Takes Place as Follows:

When the card has to transmit data to the reader, it modulates the alternating magnetic field by means of load modulation technique. This modulation on the magnetic field is reflected on the reader's receive antenna as a modulated electrical signal. The reader demodulates this electrical signal and uses it for receiving data from the card.

When the card sends data to the reader by means of modulating the alternating magnetic field, it is impossible for the card to modulate the entire magnetic field due to the geometry of the flux lines. Hence only some part of the magnetic flux lines are modulated and other part of the flux lines are not modulated. While receiving data from the card, if the receive antenna in the reader captures all flux lines, then the received signal strength ratio becomes less.

Whereas if the receive antenna geometry is so arranged to capture maximum number of modulated flux lines and minimum number of un-modulated flux lines, then the received signal strength ratio is more. As the received signal strength increases, it enables the reader to read cards at larger operating distance than before. As the received signal strength increases, it enables the reader to read without errors caused by the external interference noises.

A simple example may be taken for the purpose of proving that more receive signal strength ratio is achieved by embodiments of the present invention. Let 1000 be the number of flux lines in total, generated by the contact-less smart card reader. Now 500 may be the number of flux lines those pass through the card. Let ±10 be the change in number of flux lines inside the card due to the load modulation. If the reader either uses a single antenna for both transmit and receive, or attempts to capture all of the flux lines in the magnetic field, then the received signal would have a voltage equivalent to 1000±10. On demodulation, this is equivalent to a signal to carrier ratio of 10/1000.

If the reader uses a separate antenna for receive and if it is so designed geometrically to capture maximum number of flux lines that pass through the card and minimum number of flux lines that do not pass though the card, say for example 600 lines, then the received signal would have a voltage equivalent to 600±10. On demodulation, this is equivalent to a signal to carrier ratio of 10/600. Obviously 10/600 is always more than 10/1000. This higher signal ratio results in increase in operating distance and error free read/write to the card.

According to embodiments of the invention, a contact-less smart card reader has separate antenna for transmitting and receiving, a receive coil having a geometrical shape so as to capture maximum number of flux lines that pass through the card and minimum number of flux lines that do not pass though the card. Preferably, the receive antenna is smaller than the transmit antenna, but bigger than the antenna size of the card. The number of transmitting antenna is at least one and the number of receiving antenna is at least one. However, the number of transmit antenna and receive antenna may be more than one.

Particular embodiments of the present invention include separate antenna coil for transmission and reception. This is to ensure that the receive coil captures different number of flux lines than the number of flux lines created by the transmit coil. The receive coil is geometrically designed so as to capture maximum number of magnetic flux lines those pass through the card and minimum number of flux lines those do not pass through the card. Thus, embodiments of the present invention create higher received signal strength. If transmit and receive antenna are arranged on the same plane with concentric centre, then obviously the receive antenna would have a lesser size and same shape of the transmitting antenna. If both the antenna do not fall in same plane or they are not concentric, then the mathematical condition is that the receive antenna must capture maximum number of magnetic flux lines that pass through the card and minimum number of magnetic flux lines that do not pass through the card.

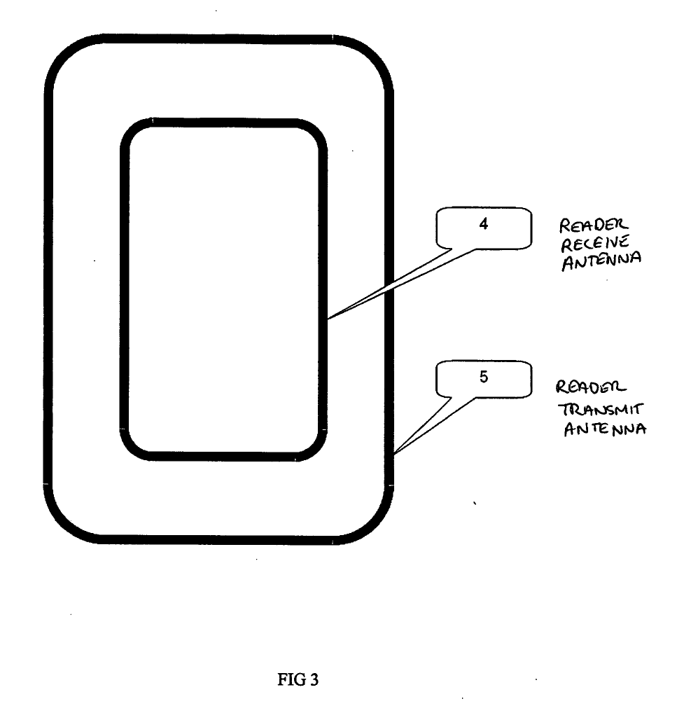

FIG. 3 illustrates a preferred embodiment of the smart card reader in accordance with the invention. The figure shows that the transmit antenna and receive antenna are fabricated on the same plane surface of a printed circuit board. It shows that both antennae are rectangular with all corners curved in shape. Both antennas are concentric to the same center point. FIG. 3 shows the top view of the antenna construction.

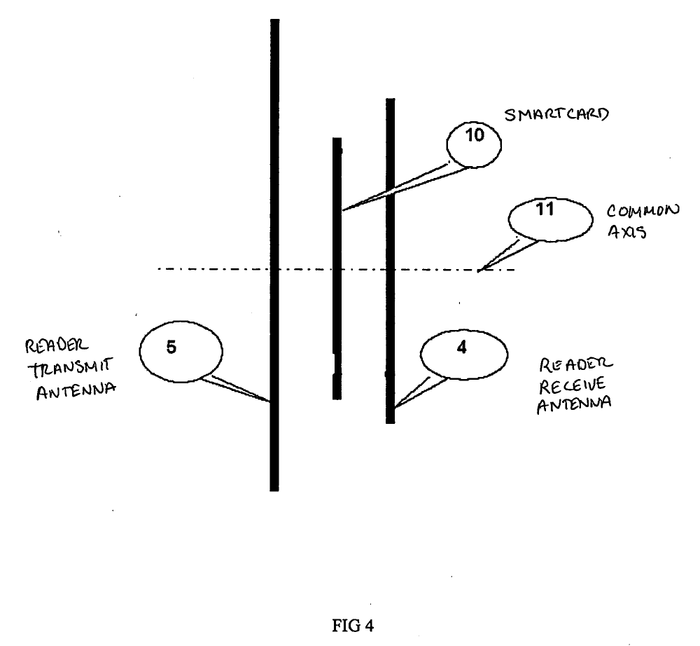

FIG. 4 illustrates a further preferred embodiment of the smart card reader in accordance with the present invention. FIG. 4 shows that the transmit antenna 5 and receive antenna 4 are fabricated on two different printed circuit boards. Both antennas are rectangular with all corners curved in shape. Both antennae are mounted on two different planes and kept concentric to the common axis 11. Transmit antenna 5 and receive antenna 4 are separated by a distance. The figure shows the side view of the printed circuit boards.

There is no limitation/condition on where the contact-less smart card 10 is positioned. The contact-less smart card can be positioned either in between the reader transmit antenna and reader receive antenna or positioned away from the reader transmit/receive antenna. In the example illustration, the card is placed in between the reader transmit antenna 5 and reader receive antenna 4.

The objects of the invention are therefore achieved by having at least two separate antenna in the reader, one for transmitting and other one for receiving such that the reader has an improved antenna geometry for increasing the signal to noise ratio in the reader and consequently, for increasing the signal qualities received from a smart card, particularly in the event of operation of said smart card from a substantial operating distance.

The present invention has been described with reference to some preferred embodiments, but it includes all legitimate developments within the scope of what has been described hereinbefore and what has been claimed hereinafter.

We claim:

1. A contact-less smart card reader comprising at least one separate transmit antenna and at least one separate receive antenna arranged to have an antenna geometry adapted to capture a maximum number of flux lines that pass through a smart card and a minimum number of flux lines that do not pass though the smart card, thereby increasing the signal to noise ratio associated with the smart card reader.

2. The reader of claim 1 wherein said receive antenna comprises a receive coil arranged to form a geometrical shape that captures the maximum number of flux lines that pass through the smart card and the minimum number of flux lines that do not pass though the smart card.

3. The reader of claim 1, further comprising a plurality of separate transmit antenna and receive antenna.

4. The reader of claim 1 wherein the receive antenna is smaller in size than the transmit antenna.

5. The reader of claim 4 wherein the receive antenna is larger in size than an antenna of the smart card.

6. The reader of claim 1 further comprising
a processor coupled to memory that issues commands or data to the smart card and receives a response from the smart card;
a reader integrated circuit that serializes and converts the commands or data into standardized frames; and
a matching circuit that matches the impedance of the smart card to a source impedance and creates resonance to drive power through the transmit antenna.

7. The reader of claim 6 wherein said matching circuit is a passive circuit, said transmit antenna is adapted to transmit power by means of an alternating magnetic field carrier wave and to transmit the commands or data to the card by means of modulation on the carrier wave, and said receive antenna is adapted to receive and forward the response from the smart card to the reader integrated circuit through the matching circuit.

8. The reader of claim 1, wherein the transmit antenna and receive antenna are arranged in different planes and are non-concentric.

9. The reader of claim 1 wherein the transmit antenna and receive antenna are arranged on a common plane, the transmit antenna and the receive antenna each having a rectangular shape with curved corners and being concentric to a common center point.

10. The reader of claim 1 wherein the transmit antenna and receive antenna are arranged on two different planes, the transmit antenna and the receive antenna each having a rectangular shape with curved corners and being concentric to a common axis.

11. A system comprising:
at least one contact-less smart card; and
a contact-less smart card reader comprising at least one separate transmit antenna and at least one separate receive antenna;
the at least one separate transmit antenna and the at least one separate receive antenna being arranged to have an antenna geometry adapted to capture a maximum number of flux lines that pass through the at least one contact-less smart card and a minimum number of flux lines that do not pass though the at least one contact-less smart card, thereby increasing the signal to noise ratio associated with the smart card reader.

12. The system of claim 11 wherein the at least one contact-less smart card is operatively positioned in between the reader transmit antenna and reader receive antenna to communicate with the contact-less smart card reader.

13. The system of claim 11 wherein the at least one contact-less smart card is operatively positioned away from the reader transmit antenna and reader receive antenna to communicate with the contact-less smart card reader.

14. A method for assembling a smart card reader comprising:
arranging at least one separate transmit antenna and at least one separate receive antenna within a housing of a smart card reader forming an antenna geometry adapted to capture a maximum number of flux lines that pass through a smart card and a minimum number of flux lines that do not pass though the smart card, thereby increasing the signal to noise ratio associated with the smart card reader.

15. The method of claim 14 further comprising designing a receive coil of said receive antenna to have a geometrical shape that captures the maximum number of flux lines that pass through the smart card and the minimum number of flux lines that do not pass through the smart card.
